(19) United States
(12) Patent Application Publication
(10) Pub. No.: US 2026/0106321 A1
(43) Pub. Date: Apr. 16, 2026

(54) SEPARATOR FOR ELECTROCHEMICAL DEVICE AND ELECTROCHEMICAL DEVICE INCLUDING THE SAME

(71) Applicant: LG ENERGY SOLUTION, LTD., Seoul (KR)

(72) Inventors: So Young YOON, Daejeon (KR); Kyung Ryun KA, Daejeon (KR); In Hyouk SUNG, Daejeon (KR); Jin Young SHIN, Daejeon (KR); Hye Won KIM, Daejeon (KR)

(73) Assignee: LG ENERGY SOLUTION, LTD., Seoul (KR)

(21) Appl. No.: 19/359,477

(22) Filed: Oct. 15, 2025

(30) Foreign Application Priority Data
Oct. 16, 2024 (KR) 10-2024-0141291
Oct. 2, 2025 (KR) 10-2025-0144910

(51) Int. Cl. H01M 50/446; H01G 11/52; H01M 10/052; H01M 50/426; H01M 50/429; H01M 50/431; H01M 50/44; H01M 50/449

(52) U.S. Cl. CPC H01M 50/446; H01M 10/052; H01M 50/426; H01M 50/4295; H01M 50/431; H01M 50/44; H01M 50/449; H01G 11/52

(57) ABSTRACT

A separator for an electrochemical device includes a porous substrate, and a coating layer formed on at least one surface of the porous substrate. The coating layer includes inorganic particles, a polymer binder, and cellulose nanofibers. Lithium ions and silane are introduced into the cellulose nanofibers so as to reduce moisture content of the separator and provide improved electrical resistance.

### CROSS REFERENCES TO RELATED APPLICATIONS

This application is based on and claims priority from Korean Patent Application No. 10-2024-0141291, filed on Oct. 16, 2024 and Korean Patent Application No. 10-2025-0144910, filed on Oct. 2, 2025, with the Korean Intellectual Property Office, the disclosure of which is incorporated herein in its entirety by reference.

### TECHNICAL FIELD

The present disclosure relates to a separator for an electrochemical device and an electrochemical device including the same.

### BACKGROUND

An electrochemical device is configured to convert chemical energy into electrical energy using an electrochemical reaction, and in recent years, lithium secondary batteries, which have high energy density and voltage, long cycle life, and are applicable in various fields, have been widely used.

A lithium secondary battery may include an electrode assembly manufactured using a positive electrode, a negative electrode, and a separator disposed between the positive electrode and the negative electrode, and the electrode assembly may be accommodated in a case together with an electrolyte.

Meanwhile, the separator of the lithium secondary battery serves to prevent electrical contact between the positive electrode and the negative electrode while allowing movement of lithium ions between the electrodes, and plays an important role in the safety and performance of the battery.

### SUMMARY

The present disclosure provides a separator for an electrochemical device having a reduced electrical resistance value due to a low moisture content, and an electrochemical device including the same.

In an aspect, the present disclosure provides a separator for an electrochemical device including a porous substrate and a coating layer formed on at least one surface of the porous substrate. The coating layer includes inorganic particles, a polymer binder, and cellulose nanofibers, into which lithium ions and silane are introduced.

In another aspect, the present disclosure provides a method for manufacturing a separator for an electrochemical device. The method includes the steps of: preparing a slurry for a coating layer (hereinafter referred to as “coating layer-forming slurry”) including inorganic particles, a polymer binder, cellulose nanofibers (CNFs), and a dispersion medium; forming the coating layer by coating the coating layer-forming slurry on at least one surface of a porous substrate; and drying the coating layer to remove the dispersion medium. The step of preparing the coating layer-forming slurry further includes a step of introducing lithium ions and a silane component into the cellulose nanofibers (CNFs).

Lithium ions and silane may be introduced into cellulose nanofibers at a molar ratio from about 5:1 to 25:1.

The coating layer may include the cellulose nanofibers in an amount from about 1 wt % to 15 wt %.

An average diameter of the cellulose nanofibers may range from about 5 nm to 50 nm.

An aspect ratio of the cellulose nanofibers may range from about 50 to 200.

The silane may be one or more selected from the group consisting of N-2-(aminoethyl)-3-aminopropylmethyldimethoxysilane, N-2-(aminoethyl)-3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, vinyltrimethoxysilane, vinyltriethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, tris-(trimethoxysilylpropyl)isocyanurate, 3-mercaptopropylmethyldimethoxysilane, 3-mercaptopropyltrimethoxysilane, and 3-isocyanatopropyltriethoxysilane.

The thickness of the coating layer may range from about 0.5 μm to 2 μm.

The content of the inorganic particles relative to the total weight of the coating layer may range from about 80 wt % to 95 wt %.

The separator for an electrochemical device may further include an adhesive layer formed on a surface of the coating layer.

In an aspect, the present disclosure provides an electrochemical device including a positive electrode, a negative electrode, and a separator disposed between the positive electrode and the negative electrode. The separator is the one for an electrochemical device according to the aspect described above.

The electrochemical device may be a lithium secondary battery.

The separator for an electrochemical device according to the present disclosure may include a hydrophobic coating layer so as to have a low moisture content and provide reduced resistance.

### DETAILED DESCRIPTION

Hereinafter, each configuration of the present disclosure will be described in more detail so that those ordinarily skilled in the art to which the present disclosure pertains may readily implement the present disclosure. However, the following description is merely an example, and the scope of protection of the present disclosure is not limited by the following description.

The term “including” as used herein is used to list materials, compositions, devices, and methods useful for the present disclosure, and is not limited to the listed examples.

As used herein, the terms “about” and “substantially” are used to account for inherent manufacturing and material tolerances (e.g., ±5%) and are used in the sense of covering a range or an approximation of numerical values or degrees. These terms are used to prevent an infringer from unfairly taking advantage of disclosures in which precise or absolute values are provided merely to aid in understanding the present disclosure.

The term “electrochemical device” as used herein may mean, for example, a primary battery, a secondary battery, or a supercapacitor.

The term “aspect ratio” as used herein means, in a fibrous material such as cellulose nanofibers in which a diameter and a length of a fiber can be measured, a value obtained by dividing the length of the fiber by the diameter thereof. The length, diameter, and aspect ratio of the fiber may be measured using a scanning electron microscope, and the aspect ratio refers to an average of aspect ratios measured for any 20 fibers.

Although the present disclosure has been described above by way of embodiments, the present disclosure is not limited thereto, and may include those obtained by combining one or more configurations among specific examples and embodiments by a person ordinarily skilled in the art. Various changes and modifications may be made within the technical idea of the present disclosure and the scope of equivalents of the claims set forth below.

A separator of a lithium secondary battery may include, on at least one surface of a porous substrate, a coating layer including a polymer binder and inorganic particles. The inorganic particles may be connected to other inorganic particles by the polymer binder to form an interstitial volume, and lithium ions may move between a positive electrode and a negative electrode through the interstitial volume. In addition to fixing the inorganic particles, the polymer binder may impart adhesion to the coating layer, and the coating layer may be adhered to each of the porous substrate and the electrodes.

The thinner the separator of a lithium secondary battery is, the higher the energy density of the battery. Accordingly, thinning of the separator is required to increase the energy density of the lithium secondary battery. Cellulose nanofibers (CNFs), which are nano-sized fibers formed by bundles of cellulose chains bound together, have excellent tensile strength while also having a low density. When cellulose nanofibers are used in separator coatings, not only can their excellent mechanical properties be utilized, but they also facilitate thinning. Therefore, the cellulose nanofibers have attracted attention as a material for separator coatings. Nevertheless, due to their high hydrophilicity, cellulose nanofibers may increase the moisture content of the separator when included in the coating layer. As the moisture content of the separator increases, the movement of lithium ions inside the secondary battery is hindered, resulting in increased electrical resistance of the secondary battery.

In view of the foregoing, the present disclosure provides a technology for securing a coating layer capable of thinning a separator by compensating for the moisture vulnerability of cellulose nanofibers.

The present disclosure provides a separator for an electrochemical device including a porous substrate and a coating layer formed on at least one surface of the porous substrate. The coating layer includes inorganic particles, a polymer binder, and cellulose nanofibers (CNFs), into which lithium ions and a silane component are introduced.

The porous substrate may be a porous film having a plurality of pores, and may electrically insulate a positive electrode and a negative electrode so as to prevent a short circuit. For example, when the electrochemical device is a lithium secondary battery, the porous substrate may be an ion-conductive barrier that allows lithium ions to pass therethrough while blocking electrical contact between the positive electrode and the negative electrode. At least some of the pores may form a three-dimensional network communicating with the surface and the interior of the porous substrate, and a fluid may pass through the porous substrate via the pores.

The porous substrate may be formed of a material that is physically and chemically stable with respect to an organic solvent electrolyte. For example, the porous substrate may include, but is not limited to, resins such as polyolefins including polyethylene, polypropylene, and polybutylene, polyvinyl chloride, polyethylene terephthalate, polycycloolefin, polyethersulfone, polyamide, polyimide, polyamide-imide, nylon, polytetrafluoroethylene, and copolymers or mixtures thereof. According to an embodiment, a polyolefin resin may be used. The polyolefin resin is processable into a relatively thin thickness and allows easy application of a coating slurry, and thus is suitable for manufacturing an electrochemical device having higher energy density.

The porous substrate may have a single-layer or multilayer structure. The porous substrate may include two or more polymer resin layers having different melting points (Tm), which may provide a shutdown function in the event of thermal runaway of the battery. For example, the porous substrate may include a polypropylene layer having a relatively high melting point and a polyethylene layer having a relatively low melting point. According to an embodiment, the porous substrate may have a three-layer structure in which polypropylene, polyethylene, and polypropylene are sequentially laminated. As the temperature of the battery rises above a predetermined temperature, the polyethylene layer may melt and shut down the pores, preventing thermal runaway of the battery.

The thickness of the porous substrate may be about 1 μm to 100 μm. For example, the thickness of the porous substrate may be about 10 μm to 90 μm, about 20 μm to 80 μm, about 30 μm to 70 μm, or about 40 μm to 60 μm. According to an embodiment, the thickness of the porous substrate may range from about 1 μm to 30 μm. Alternatively, the thickness of the porous substrate may range from about 5 μm to 15 μm, or from about 8 μm to 13 μm. By adjusting the thickness of the porous substrate within the above ranges, it may be possible to minimize the volume of the electrochemical device while increasing the amount of active material contained in the electrochemical device and electrically insulating a positive electrode and a negative electrode.

The porous substrate may include pores having an average diameter from about 0.01 μm to 1 μm. For example, the size of the pores included in the porous substrate may be about 0.01 μm to 0.09 μm, about 0.02 μm to 0.08 μm, about 0.03 μm to 0.07 μm, or about 0.04 μm to 0.06 μm. For example, the size of the pores may range from about 0.02 μm to 0.06 μm. By adjusting the pore size of the porous substrate within the above ranges, the overall air permeability and ionic conductivity of the manufactured separator may be adjusted.

The porous substrate may have an air permeability from about 10 s/100 cc to 100 s/100 cc. For example, the air permeability of the porous substrate may be about 10 s/100 cc to 90 s/100 cc, about 20 s/100 cc to 80 s/100 cc, about 30 s/100 cc to 70 s/100 cc, or about 40 s/100 cc to 60 s/100 cc. According to an embodiment, the air permeability of the porous substrate may range from about 50 s/100 cc to 70 s/100 cc. When the air permeability of the porous substrate is within the above ranges, the air permeability of the manufactured separator may be provided in a range suitable for securing the output and cycle characteristics of the electrochemical device.

The air permeability (s/100 cc) refers to the time (seconds) required for 100 cc of air to pass through a predetermined area of the porous substrate or separator under a constant pressure. The air permeability may be measured using a permeability tester (Gurley densometer) according to ASTM D 726-58, ASTM D 726-94, or JIS-P8117. For example, the time required for 100 cc of air to pass through a sample having an area of 1 square inch (or 6.54 cm²) under an air pressure of 0.304 kPa or a water pressure of 1.215 kN/m² may be measured using a Gurley 4110N instrument. For example, the time required for 100 cc of air to pass through a sample having an area of 1 square inch under a constant water pressure of 4.8 inches at room temperature may be measured using an Asahi Seico EG01-55-1MR instrument.

The porous substrate may have a porosity from about 10 vol % to 60 vol %. For example, the porosity of the porous substrate may be about 15 vol % to 55 vol %, about 20 vol % to 50 vol %, about 25 vol % to 45 vol %, or about 30 vol % to 40 vol %. According to an embodiment, the porosity of the porous substrate may range from about 30 vol % to 50 vol %. When the porosity of the porous substrate is within the above ranges, the ionic conductivity of the manufactured separator may be provided in a range suitable for securing the output and cycle characteristics of the electrochemical device.

The porosity refers to the volume ratio of pores to the total volume of the porous substrate. The porosity may be measured by a method known in the art. For example, the porosity may be measured by a Brunauer-Emmett-Teller (BET) method using nitrogen gas adsorption, a capillary flow porometer method, or a water or mercury intrusion method.

The coating layer is formed on at least one surface of the porous substrate and includes inorganic particles, a polymer binder, and cellulose nanofibers (CNFs). The coating layer may be formed by coating, on at least one surface of the porous substrate, a coating slurry including inorganic particles, a polymer binder, cellulose nanofibers (CNFs), and a dispersion medium. The coating layer includes an interstitial volume in which the inorganic particles are connected by the polymer binder or the cellulose nanofibers (CNFs), and is adhered to the porous substrate to prevent thermal shrinkage of the porous substrate while allowing lithium ions to pass therethrough.

The dispersion medium may be one selected from water, ethanol, acetone, isopropyl alcohol (IPA), dimethylacetamide (DMAc), dimethylformamide (DMF), N-methyl-2-pyrrolidone (NMP), acetonitrile, and combinations thereof. According to an embodiment, the dispersion medium may be a mixture of water and isopropyl alcohol, or water. By using the above types of dispersion media, a coating layer in which the inorganic particles, polymer binder, and cellulose nanofibers are uniformly dispersed may be formed.

The coating slurry may further include additives such as a dispersant, a surfactant, a defoaming agent, and a flame retardant, so as to improve dispersibility and flame retardancy and enhance the uniformity of the formed coating layer. For example, the dispersant may include one or more selected from polyacrylic acid, oil-soluble polyamine, oil-soluble amine compounds, fatty acids, fatty alcohols, sorbitan fatty acid esters, tannic acid, and pyrogallol. By using the above types of dispersants, the stability of the coating slurry may be improved and the uniformity of the coating layer formed from the coating slurry may be ensured.

Based on the total weight of the coating slurry, the additive may be included in an amount from about 0 wt % to 5 wt %. For example, the content of the additive may be about 0.01 wt % to 4 wt %, about 0.1 wt % to 3 wt %, or about 1 wt % to 2 wt %. For example, the content of the additive may range from about 1 wt % to 5 wt %. By adjusting the content of the additive within the above ranges, uniform dispersion and stability of the inorganic particles contained in the coating slurry may be achieved.

The dispersion medium contained in the coating slurry may be removed by drying or heating after the formation of the coating layer. During the process of removing the dispersion medium, a plurality of pores may be formed on the surface and within the coating layer. The pores may include interstitial volumes formed between the inorganic particles, and may have a structure forming a three-dimensional network through which a fluid may pass.

The polymer binder may bind the inorganic particles contained in the coating layer and impart adhesion to the coating layer. The polymer binder may be a solution type dissolved in the dispersion medium of the coating slurry, a particle type that is not dissolved in the dispersion medium and maintains a particulate form in the coating slurry and the coating layer, or a combination thereof, but is not limited thereto. The polymer binder may include an acrylic binder, a fluorine-based binder, or a hybrid binder thereof, but is not limited thereto. For example, the acrylic binder may be one or more selected from polyacrylic acid, polyacrylamide, methyl acrylate, ethyl acrylate, isopropyl acrylate, n-butyl acrylate, isobutyl acrylate, ethylhexyl acrylate, methyl methacrylate, styrene-butadiene rubber, nitrile-butadiene rubber, acrylonitrile-butadiene rubber, acrylonitrile-butadiene-styrene rubber, and copolymers including one or more of the foregoing. For example, the fluorine-based binder may be one or more selected from polyvinylidene fluoride, polyvinylidene fluoride-hexafluoropropylene, and polyvinylidene fluoride-trichloroethylene.

The inorganic particles may be electrochemically stable. The inorganic particles are not particularly limited as long as they do not undergo oxidation and/or reduction reactions within the operating voltage range of the electrochemical device (e.g., 0 to 5 V based on Li/Li). When high dielectric constant inorganic particles are used as the inorganic particles, they may contribute to increasing the degree of dissociation of an electrolyte salt, such as a lithium salt, in a liquid electrolyte, improving the ionic conductivity of the electrolyte. For the above reasons, the inorganic particles may include high dielectric constant inorganic particles having a dielectric constant of about 5 or greater, for example, about 10 or greater. Non-limiting examples of inorganic particles having a dielectric constant of about 5 or greater include BaTiO₃, Pb(Zr,Ti)O₃(PZT), Pb₁₋ₓLaₓZr_{1-γ}Ti_{γ}O₃ (PLZT, 0<x<1, 0<y<1), Pb(Mg_{1/3}Nb_{2/3})O₃—PbTiO₃(PMN-PT), HfO₂, SrTiO₃, SnO₂, CeO₂, MgO, NiO, CaO, ZnO, ZrO₂, SiO₂, Y₂O₃, Al₂O₃, Al(OH)₃, SiC, AlOOH, TiO₂, or mixtures thereof.

Inorganic particles having lithium ion transfer capability, that is, inorganic particles that contain lithium elements but do not store lithium and have a function of transporting lithium ions, may be used as the inorganic particles. Non-limiting examples of inorganic particles having lithium ion transfer capability include lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} glass such as 14Li₂O-9Al₂O₃-38TiO₂-39P₂O₅(0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5) such as Li_{3.25}Ge_{0.25}P_{0.75}S₄, lithium nitride (LiₓN_{y}, 0<x<4, 0<y<2) such as Li₃N, SiS₂-based glass (LiₓSi_{y}S_{z}, 0<x<3, 0<y<2, 0<z<4) such as Li₃PO₄—Li₂S—SiS₂, P₂S₅-based glass (LiₓP_{y}S_{z}, 0<x<3, 0<y<3, 0<z<7) such as LiI—Li₂S—P₂S₅, or mixtures thereof.

In addition, flame-retardant inorganic particles, which can impart flame-retardant properties to the separator or prevent the temperature inside the electrochemical device from rapidly increasing, may be used as the inorganic particles. Non-limiting examples of flame-retardant inorganic particles include Sb₂O₃, Sb₂O₄, Sb₂O₅, SrTiO₃, SnO₂, CeO₂, MgO, Mg(OH)₂, NiO, CaO, ZnO, Zn₂SnO₄, ZnSnO₃, ZnSn(OH)₆, ZrO₂, Y₂O₃, SiO₂, Al₂O₃, AlOOH, Al(OH)₃, SiC, TiO₂, H₃BO₃, HBO₂, and mixtures thereof.

The average particle diameter (D50) of the inorganic particles may be about 50 nm to 4,000 nm. For example, the average particle diameter (D50) of the inorganic particles may be about 100 nm to 3,500 nm, about 200 nm to 3,000 nm, about 300 nm to 2,000 nm, about 400 nm to 1,000 nm, or about 400 nm to 800 nm. When the average particle diameter of the inorganic particles is less than 50 nm, it may be disadvantageous in terms of electrical resistance because additional polymer binder is required for bonding between the inorganic particles as the specific surface area increases. When the average particle diameter of the inorganic particles exceeds 4,000 nm, the uniformity of the surface of the coating layer may be reduced, damage to the porous substrate or electrode may be caused during lamination, and the thickness of the coating layer may increase, making it difficult to implement thinning.

The cellulose nanofibers (CNFs) have excellent physical properties such as tensile strength and elastic modulus relative to their low density. When the cellulose nanofibers (CNFs) are included in the coating layer, excellent mechanical strength may be imparted to the separator even with a small amount. In addition, due to the fibrous bundle form of the cellulose nanofibers (CNFs) having a large surface area, the dispersibility of solids including the inorganic particles in the coating slurry may be improved. Furthermore, the cellulose nanofibers (CNFs) may uniformly bind the inorganic particles in the coating layer, implementing a thin coating layer and achieving thinning of the separator. Moreover, since the cellulose nanofibers (CNFs) have excellent heat resistance, they may alleviate thermal shrinkage problems that may occur in a thin coating layer.

Metal ions may be introduced into the cellulose nanofibers (CNFs). For example, lithium ions may be introduced into the cellulose nanofibers (CNFs). The cellulose nanofibers (CNFs) may have lithium ions ionically bonded to at least one terminal functional group. The cellulose nanofibers (CNFs) bonded with lithium ions may improve the ionic conductivity of the separator, reduce resistance, and enhance the output and cycle characteristics of the electrochemical device.

According to an embodiment, the cellulose nanofibers (CNFs) may be modified such that at least a portion of the cellulose is modified. The cellulose nanofibers (CNFs) may each have at least one terminal functional group substituted through surface modification, and metal ions may be easily introduced through the substituted functional groups. The cellulose nanofibers (CNFs) may be oxidized, carboxymethylated, or phosphorylated. For example, the cellulose nanofibers (CNFs) may be surface-modified by TEMPO (2,2,6,6-tetramethylpiperidine-1-oxyl radical) catalytic oxidation, carboxymethylation, or phosphorylation. For example, the cellulose nanofibers (CNFs) may have at least one terminal substituted with a carboxyl group carrying a negative charge through TEMPO catalytic oxidation. When the TEMPO-catalytically oxidized cellulose nanofibers (CNFs) come into contact with lithium ions, the lithium ions may be bonded to the carboxyl groups and introduced in the form of lithium carboxylate (COO—Li⁺).

According to an embodiment, a silane component may be introduced into the cellulose nanofibers (CNFs). The cellulose nanofibers (CNFs) have a problem in that high hydrophilicity due to terminal hydroxyl groups or substituted carboxyl groups increases the moisture content of the separator. The cellulose nanofibers (CNFs) also have a problem in that the separator is impregnated with moisture during the manufacture of the separator or the manufacture or storage of the electrochemical device, which deteriorates the lifetime of the electrochemical device. The cellulose nanofibers (CNFs) may be bound with a moiety containing a silane group through at least one terminal functional group. The cellulose nanofibers (CNFs) into which the silane group is introduced may be imparted with hydrophobicity by the silane group, which may alleviate the vulnerability of the separator to moisture. For example, the silane may be coupled to one or more terminal hydroxyl groups of the cellulose nanofibers (CNFs), and may impart hydrophobicity to the surface of the cellulose nanofibers (CNFs).

The silane may be a substance having an organofunctional group, which includes, for example, an amino group, a vinyl group, a methacryl group, an acryl group, an isocyanate group, a mercapto group, or an epoxy group. This organofunctional group is substituted into methyltrimethoxysilane (MTMS), tetraethoxysilane (TEOS), methyltriethoxysilane (MTES), and dimethyldiethoxysilane (DMDS), which are classified according to a hydrolyzing group. For example, the silane may be one or more selected from the group consisting of N-2-(aminoethyl)-3-aminopropylmethyldimethoxysilane, N-2-(aminoethyl)-3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, vinyltrimethoxysilane, vinyltriethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, tris-(trimethoxysilylpropyl)isocyanurate, 3-mercaptopropylmethyldimethoxysilane, 3-mercaptopropyltrimethoxysilane, and 3-isocyanatopropyltriethoxysilane. By appropriately using the above-described types of silane to modify the surface of the cellulose nanofibers (CNFs), the moisture content of the separator may be reduced and the resistance may be improved.

According to an embodiment, lithium ions and silane may be introduced into the cellulose nanofibers (CNFs). Lithium ions and silane may be introduced into the cellulose nanofibers (CNFs) at a molar ratio of about 5:1 to 25:1. For example, lithium ions and silane may be introduced into the cellulose nanofibers (CNFs) at a molar ratio of about 6:1 to 25:1, 7:1 to 25:1, 10:1 to 25:1, 5:1 to 22:1, 6:1 to 22:1, 7:1 to 22:1, 10:1 to 22:1, 15:1 to 25:1, 15:1 to 22:1, or 20:1 to 22:1. When silane is introduced in an amount less than the above range, the moisture vulnerability increases, which may lead to an increase in the electrical resistance of the electrochemical device and a deterioration in the cycle characteristics. When silane is introduced excessively beyond the above range, the inherent tensile strength and elasticity of the cellulose nanofibers (CNFs) may decrease, and the mechanical properties including the puncture strength of the separator may be reduced. By introducing lithium ions and silane into the cellulose nanofibers (CNFs) at a molar ratio within the above range, excellent mechanical properties of the cellulose nanofibers (CNFs) may be maintained, while imparting hydrophobicity. Therefore, a separator with reduced moisture content and low resistance may be provided.

The average diameter of the cellulose nanofibers (CNFs) may range from about 5 nm to 50 nm. For example, the average diameter of the cellulose nanofibers (CNFs) may be about 5 nm or more, 10 nm or more, 15 nm or more, 20 nm or more, 25 nm or more, 30 nm or less, 35 nm or less, 40 nm or less, 45 nm or less, or 50 nm or less. When the average diameter of the cellulose nanofibers (CNFs) satisfies the above range, the pores of the coating layer may not be blocked, ensuring that air permeability is excellent and the electrical resistance of the separator is reduced. In addition, when the average diameter of the cellulose nanofibers (CNFs) satisfies the above range, it may be easy to introduce lithium ions and silane components into the surfaces due to the high surface area.

The average length of the cellulose nanofibers (CNFs) may range from about 1 μm to 10 μm. For example, the average length of the cellulose nanofibers (CNFs) may be about 1 μm or more, 2 μm or more, 3 μm or more, 4 μm or more, 5 μm or more, 6 μm or less, 7 μm or less, 8 μm or less, 9 μm or less, or 10 μm or less. When the average length of the cellulose nanofibers (CNFs) satisfies the above range, the dispersibility of the cellulose nanofibers (CNFs) with inorganic particles and a polymer binder in the coating slurry may be excellent, and the pores may not be blocked during the formation of the coating layer, ensuring excellent air permeability of the separator.

The aspect ratio of the cellulose nanofibers (CNFs) may range from about 50 to 200. For example, the aspect ratio of the cellulose nanofibers (CNFs) may be about 50 or more, 60 or more, 70 or more, 80 or more, 90 or more, 100 or more, 110 or less, 120 or less, 140 or less, 160 or less, 180 or less, or 200 or less. When the aspect ratio of the cellulose nanofibers (CNFs) satisfies the above range, aggregation of the cellulose nanofibers may be prevented so as to ensure excellent mechanical properties, and lithium ions and silane components may be easily introduced into the cellulose nanofibers (CNFs).

The coating layer may include the inorganic particles in an amount from about 80 wt % to 95 wt %, based on the total weight of the coating layer. For example, the content of the inorganic particles based on 100 wt % of the coating layer may be about 80 wt % to 95 wt %, about 81 wt % to 94 wt %, about 82 wt % to 93 wt %, about 83 wt % to 92 wt %, about 84 wt % to 91 wt %, about 85 wt % to 90 wt %, about 86 wt % to 89 wt %, or about 87 wt % to 88 wt %. According to an embodiment, the content of the inorganic particles based on 100 wt % of the coating layer may range from about 85 wt % to 95 wt %, or from about 90 wt % to 95 wt %. A coating layer satisfying the above range may be bound to the porous substrate so as to minimize thermal shrinkage of the porous substrate.

The coating layer may include the cellulose nanofibers (CNFs) in an amount from about 1 wt % to 15 wt %. For example, the coating layer may include the cellulose nanofibers (CNFs) in an amount of about 1 wt % to 15 wt %, about 1 wt % to 10 wt %, 1 wt % to 8 wt %, about 1 wt % to 6 wt %, about 1 wt % to 5 wt %, 3 wt % to 15 wt %, about 3 wt % to 10 wt %, about 3 wt % to 8 wt %, about 3 wt % to 6 wt %, or about 3 wt % to 5 wt %. A coating layer satisfying the above range may be formed with a thin thickness, enabling thinning, and at the same time, exhibiting excellent mechanical strength. In addition, when the above range is satisfied, the cellulose nanofibers (CNFs) dispersed in the coating layer may be easily bound to the inorganic particles, the porous substrate, and the electrode, which may improve the adhesion of the separator.

The thickness of the coating layer may range from about 0.5 μm to 2 μm. For example, the thickness of the coating layer may be about 0.5 μm to 1.75 μm, 0.5 μm to 1.5 μm, 0.5 μm to 1.25 μm, or 0.5 μm to 1 μm. By adjusting the thickness of the coating layer within the above range, lithium ions may easily pass through the coating layer, reducing the resistance of the separator. By adjusting the thickness of the coating layer within the above range, the mechanical strength of the porous substrate may be supplemented, and thinning of the separator may be implemented, so that an electrochemical device with high energy density may be implemented.

The separator for an electrochemical device may further include an adhesive layer formed on a surface of the coating layer. The adhesive layer may cover at least a portion of the surface of the coating layer and may impart adhesion of the separator to an electrode. The adhesive layer may be formed by additionally applying an adhesive layer-forming slurry including a polymer binder for the adhesive layer to the surface of the coating layer formed by drying the above-described coating slurry, and drying the adhesive layer-forming slurry. The applying may be performed using a bar coater, a wire bar coater, a roll coater, a spray coater, a spin coater, an inkjet coater, a screen coater, a reverse coater, a gravure coater, a knife coater, a slot die coater, a hot-melt coater, a comma coater, or a direct metering coater, but is not limited thereto. According to an embodiment, the adhesive layer may be formed by spraying and drying the adhesive layer-forming slurry. The adhesive layer may cover about 20% to 80% based on the surface of the coating layer.

The polymer binder for the adhesive layer may be the same as or different from the polymer binder described above. According to an embodiment, the polymer binder for the adhesive layer may be a fluorine-based binder, an acryl-based binder, or a mixture thereof. For example, the fluorine-based binder may be a particulate polyvinylidene fluoride-based binder. Alternatively, the adhesive layer may include both the fluorine-based binder and the acryl-based binder, so that adhesion of the separator to the electrode may be stably maintained in both a dry state without an electrolyte and a wet state in which the separator is impregnated with an electrolyte. For example, the adhesive layer may include the fluorine-based binder and the acryl-based binder in a weight ratio from about 2:8 to 8:2, from about 3:7 to 7:3, or from about 4:6 to 6:4 as the polymer binder for the adhesive layer. The thickness of the adhesive layer may be formed to be smaller than the thickness of the coating layer, so as to provide adhesion to the electrode while minimizing deterioration of air permeability of the separator.

The separator for an electrochemical device may have an electrical resistance of about 0.60 Ohm or less. For example, the electrical resistance of the separator for an electrochemical device may be about 0.40 Ohm or more, about 0.45 Ohm or more, about 0.49 Ohm or more, about 0.60 Ohm or less, about 0.65 Ohm or less, about 0.70 Ohm or less, about 0.75 Ohm or less, or about 0.80 Ohm or less. When the electrical resistance of the separator for an electrochemical device is within the above range, the output of the electrochemical device may be excellent and the cycle characteristics may be ensured.

The separator for an electrochemical device may have an air permeability from about 80 s/100 cc to 105 s/100 cc. For example, the air permeability of the separator for an electrochemical device may be about 85 s/100 cc to 105 s/100 cc, or about 85 s/100 cc to about 100 s/100 cc. When the separator for an electrochemical device is within the above range, the output, stability, and cycle characteristics of the electrochemical device may be ensured.

The separator for an electrochemical device may have a puncture strength of about 400 gf or more. For example, the puncture strength of the separator for an electrochemical device may be about 420 gf or more, about 450 gf or more, about 460 gf or more, about 470 gf or more, about 500 gf or more, about 700 gf or less, or about 670 gf or less. The puncture strength refers to the resistance of the separator to penetration of an external object. For example, the puncture strength may be tested by measuring a force applied when a needle or pin having a predetermined diameter vertically penetrates the separator at a predetermined speed, using ASTM D5748-95 and ASTM D4649.

The separator for an electrochemical device may have a moisture content of about 1,700 ppm or less. For example, the separator for an electrochemical device may have a moisture content of about 1,600 ppm or less, about 1,500 ppm or less, about 1,300 ppm or less, about 1,100 ppm or less, about 500 ppm or more, about 700 ppm or more, or about 800 ppm or more. When the moisture content of the separator for an electrochemical device is within the above range, lithium ions may easily pass through upon impregnation with an electrolyte, which may reduce the electrical resistance of the electrochemical device and improve the output, stability, and cycle performance.

The moisture content may refer to an amount of moisture impregnated into the separator during the manufacture of the separator having the coating layer, or during the manufacture or storage of the electrochemical device. The moisture content may be measured by the Karl Fischer method. For example, the moisture content may be measured using a Metrohm Karl Fischer moisture analyzer.

The separator for an electrochemical device may have a water contact angle of about 900 or more. For example, the separator for an electrochemical device may have a water contact angle of about 950 or more, about 100° or more, about 1050 or more, about 1100 or more, about 1200 or more, 1300 or more, about 1800 or less, or about 1500 or less. When the water contact angle of the separator for an electrochemical device is within the above range, hydrophobic properties may be imparted to the coating layer, which may reduce the moisture content of the separator and the cell resistance of the electrochemical device.

The water contact angle may be measured according to a static contact angle measurement method such as the sessile drop method, or a dynamic contact angle measurement method such as the tilting drop method, the captive drop method, or the Wilhelmy plate method, but is not limited thereto. The water contact angle may be the contact angle of a water droplet measured by using a commonly used contact angle measuring instrument under room temperature conditions and maintained even after a predetermined time has elapsed.

A method of manufacturing a separator for an electrochemical device according to an embodiment of the present disclosure may include the steps of: preparing a coating layer-forming slurry including inorganic particles, a polymer binder, cellulose nanofibers (CNFs), and a dispersion medium; coating at least one surface of a porous substrate with the coating layer-forming slurry to form the coating layer; and drying the coating layer and removing the dispersion medium to manufacture the separator. Descriptions overlapping with those of the separator for an electrochemical device may be replaced with the descriptions of the preceding embodiments.

The step of preparing the coating layer-forming slurry may further include a step of introducing lithium ions and a silane component into the cellulose nanofibers (CNFs). For example, the step of introducing the lithium ions and the silane component may be bringing the cellulose nanofibers (CNFs) into contact with lithium ions and silane in the dispersion medium. According to an embodiment, the step of introducing the lithium ions and the silane component may be adding a lithium compound and a silane compound to the cellulose nanofiber (CNF) dispersion and stirring the dispersion. The lithium compound may be, for example, lithium hydroxide or lithium carbonate, but other lithium compounds known in the art may also be used. By adjusting the weight ratio of the lithium compound and the silane compound, the lithium ions and the silane may be introduced into the cellulose nanofibers (CNFs) at a molar ratio within the above-described range.

The step of coating with the coating layer-forming slurry may be coating at least one surface of the porous substrate with a coating layer-forming slurry including a polymer binder, inorganic particles, and a dispersion medium. For example, the coating may be formed by using a bar coater, a wire bar coater, a roll coater, a spray coater, a spin coater, an inkjet coater, a screen coater, a reverse coater, a gravure coater, a knife coater, a slot die coater, a hot-melt coater, a comma coater, or a direct metering coater, but is not limited thereto. According to an embodiment, the step of coating with the coating layer-forming slurry may be coating one side of the porous substrate or simultaneously coating both sides with the coating layer-forming slurry using a bar coater or a slot die coater.

The step of coating with the coating layer-forming slurry may further include a step of corona discharge treatment on at least one surface of the porous substrate. For example, it may be coating the porous substrate with the coating layer-forming slurry after the step of corona discharge treatment. The step of corona discharge treatment on at least one surface of the porous substrate may prevent a decrease in adhesion between the surface of the porous substrate and the surface of the coating layer at high temperature, and may prevent or suppress a decrease in adhesion between these surfaces caused by the electrolyte.

The corona discharge treatment may be treating at least one surface of the porous substrate in air with a voltage from about 0.1 kV to 10 kV. For example, the corona discharge treatment may be treating the at least one surface of the porous substrate in air with a voltage of about 0.2 kV to 9 kV, about 0.3 kV to 8 kV, about 0.4 kV to 7 kV, about 0.5 kV to 6 kV, about 0.6 kV to 5 kV, about 0.7 kV to 4 kV, about 0.8 kV to 3 kV, about 0.9 kV to 2 kV, or about 1.0 kV to 2 kV. According to an embodiment, the corona discharge treatment may be treating the at least one surface of the porous substrate in air with a voltage of about 1.8 kV. By adjusting the applied voltage of the corona discharge treatment within the above range, an appropriate number of functional groups may be formed on the surface of the porous substrate, and damage to the surface of the porous substrate may be prevented.

The step of drying the coating layer-forming slurry and removing the dispersion medium to manufacture the separator may be drying or heating the coating layer to evaporate the dispersion medium contained in the coating layer. The removing of the dispersion medium may be performed at a temperature that evaporates only the dispersion medium contained in the coating layer without deforming the polymer binder included in the coating layer. For example, the removing of the dispersion medium may be heating the coating layer to a predetermined temperature such that the surface temperature of the coating layer does not exceed about 60° C. When heating the coating layer under the above conditions, thermal energy may be first used to heat and phase-change the dispersion medium, and may not be used to deform the polymer binder.

The method of manufacturing the separator for an electrochemical device may further include a step of forming an adhesive layer by applying and drying an adhesive layer-forming slurry on the surface of the coating layer. For example, after forming the coating layer by drying the coating layer-forming slurry and removing the dispersion medium, the adhesive layer may be formed by applying and drying the adhesive layer-forming slurry on the surface of the coating layer.

A cylindrical lithium secondary battery according to an embodiment of the present disclosure is an electrochemical device including a positive electrode, a negative electrode, and a separator interposed between the positive electrode and the negative electrode. The separator is the one for an electrochemical device according to the above-described embodiment. The cylindrical lithium secondary battery may be manufactured by inserting an electrode assembly including a positive electrode, a negative electrode, and a separator interposed between the positive electrode and the negative electrode into a battery case and sealing the battery case. Before sealing the battery case, an electrolyte may be injected so that the electrode assembly is impregnated with the electrolyte. In this embodiment, a cylindrical lithium secondary battery is illustrated as the electrochemical device, but the present disclosure is not limited thereto, and may be applied to other types of secondary batteries. For example, the electrochemical device may be a cylindrical, prismatic, coin-type, or pouch-type lithium secondary battery.

The positive electrode and the negative electrode may be those in which an electrode active material is applied and dried to be coated on at least one surface of each current collector. The current collector may be made of a material having conductivity without causing a chemical change in the electrochemical device. For example, the current collector for the positive electrode may be aluminum, nickel, titanium, baked carbon, stainless steel, or a material obtained by surface-treating aluminum or stainless steel with, for example, carbon, nickel, titanium, or silver, but is not limited thereto. For example, the current collector for the negative electrode may be copper, nickel, titanium, baked carbon, stainless steel, or a material obtained by surface-treating copper or stainless steel with, for example, carbon, nickel, titanium, or silver, but is not limited thereto. The current collector may be in various forms such as a metal sheet, a film, a foil, a net, a porous body, or a foam.

The positive electrode includes a positive electrode current collector and a positive electrode active material layer provided on at least one surface of the current collector. The positive electrode active material layer includes a positive electrode active material, a conductive material, and a binder resin. The positive electrode active material may include one or a mixture of two or more: layered compounds such as lithium manganese composite oxides (e.g., LiMn₂O₄, LiMnO₂), lithium cobalt oxide (LiCoO₂), and lithium nickel oxide (LiNiO₂), or compounds substituted with one or more transition metals; lithium manganese oxides such as Li₁₊ₓMn₂₋ₓO₄ (where x=0 to 0.33), LiMnO₃, LiMn₂O₃, or LiMnO₂; lithium copper oxide (Li₂CuO₂); vanadium oxides such as LiV₃O₈, LiV₃O₄, V₂O₅, or Cu₂V₂O₇; Ni-site lithium nickel oxides represented by the chemical formula LiNi₁₋ₓMₓO2 (where M=Co, Mn, Al, Cu, Fe, Mg, B, or Ga, and x=0.01 to 0.3); lithium manganese composite oxides represented by the chemical formula LiMn₁₋ₓMO₂ (where M=Co, Ni, Fe, Cr, Zn, or Ta, and x=0.01 to 0.1) or Li₂Mn₃MO₈ (where M=Fe, Co, Ni, Cu, or Zn); LiMn₂O₄ in which a portion of the Li in its chemical formula is substituted with an alkaline earth metal ion; disulfide compounds; and Fe₂(MoO₄)₃.

The negative electrode includes a negative electrode current collector and a negative electrode active material layer provided on at least one surface of the current collector. The negative electrode active material layer includes a negative electrode active material, a conductive material, and a binder resin. The negative electrode may include, as a negative electrode active material, one or a mixture of two or more selected from the group consisting of: lithium metal oxides; carbonaceous materials such as non-graphitizable carbon and graphitic carbon; silicon-based materials such as LiₓFe₂O₃ (0≤x≤1), LiₓWO₂ (0≤x≤1), Si, SiOₓ (0<x<2), SiC, or Si alloys; metal composite oxides such as SnₓMe₁₋ₓMe′_{γ}O_{z} (Me: Mn, Fe, Pb, Ge; Me′: Al, B, P, Si, Group 1, Group 2, or Group 3 elements of the periodic table, halogens; 0<x≤1; 1≤y≤3; 1≤z≤8); lithium metal; lithium alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxides.

The conductive material may be one or a mixture of two or more selected from graphite, carbon black, carbon fibers, metal fibers, metal powder, conductive whiskers, conductive metal oxides, carbon nanotubes, activated carbon, and polyphenylene derivatives. According to an embodiment, the conductive material may be one or a mixture of two or more selected from natural graphite, artificial graphite, acetylene black, channel black, furnace black, lamp black, thermal black, aluminum powder, nickel powder, zinc oxide, potassium titanate, and titanium oxide.

As the binder resin, a binder resin commonly used for electrodes of electrochemical devices may be used. Non-limiting examples of such binder resins may include polyvinylidene fluoride-co-hexafluoropropylene, polyvinylidene fluoride-co-trichloroethylene, polymethyl methacrylate, polyethylhexyl acrylate, polybutyl acrylate, polyacrylonitrile, polyvinylpyrrolidone, polyvinyl acetate, polyethylene-co-vinyl acetate, polyethylene oxide, polyarylate, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, and carboxyl methyl cellulose, but are not limited thereto.

The electrolyte may be a salt having a structure of A⁺B⁻, in which A⁺ includes alkali metal cations such as Li⁺, Na⁺, or K⁺, or a combination thereof, and B⁻ includes anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, or C(CF₂SO₂)₃⁻, or a combination thereof. The salt may be dissolved or dissociated in an organic solvent selected from propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), γ-butyrolactone, or a mixture thereof, but is not limited thereto.

The electrochemical device including the electrode assembly may be used as a unit cell, and may be used as a battery module including the unit cell, a battery pack including the battery module, or a device including the battery pack as a power source. The device may include, but is not limited to, small devices such as computers, mobile phones, or power tools; electric vehicles, such as electric vehicles (EVs) powered by an electric motor, hybrid electric vehicles (HEVs), or plug-in hybrid electric vehicles (PHEV); electric two-wheeled vehicles, such as an electric bicycle (E-bike) or an electric scooter (E-scooter); electric golf carts; or medium- and large-sized devices such as power storage systems.

Hereinafter, the present disclosure will be described in more detail through examples and experimental examples. The following examples and experimental examples are provided for illustrative purposes only, and the present disclosure is not limited by the following examples and experimental examples.

### Example 1

### Preparation of Cellulose Nanofibers (CNFs)

TEMPO-oxidized cellulose nanofibers (CNFs) (average diameter: 25 nm, average length: 5 μm) were prepared. Lithium hydroxide (LiOH·H₂O, Duksan Pure Chemicals) was prepared as a material for introducing lithium ions. 3-aminopropyltriethoxysilane (Sigma Aldrich) (hereinafter referred to as “APTES”) was prepared as a silane material.

The prepared cellulose nanofibers (CNFs) were dispersed in distilled water (DI water) to prepare a cellulose nanofiber dispersion. Lithium hydroxide and APTES were added to the dispersion at a molar ratio of 20:1, and stirred for 5 minutes at 30° C. (stirring device: sonication) to introduce lithium ions and silane into the cellulose nanofibers (CNFs). After stirring was complete, the cellulose nanofibers (CNFs) were filtered, washed with ethanol, and dried at 60° C. to prepare Li-CNF-APTES. As a result of XPS analysis of the Li-CNF-APTES, it was confirmed that lithium ions and APTES were bonded to the surface of the cellulose nanofibers (CNFs).

### Preparation of Coating Slurry

Al₂O₃ (particle size: 400 nm) was prepared as the inorganic particles, and PVdF (Thermo Scientific Chemical) was prepared as the polymer binder. The inorganic particles, polymer binder, and Li-CNF-APTES were added to distilled water at a weight ratio of 94:3:3, and stirred for 60 minutes to prepare the coating slurry.

### Preparation of Porous Substrate

A polyethylene film with a thickness of 10 μm was used as the porous substrate. This film was manufactured by extruding polyethylene resin and using a wet process (MI: 0.2 g/10 min, Tₘ: 135° C., porosity: 45%, average pore size: 45 nm).

### Manufacture of Separator

The coating slurry was bar-coated onto one side of a polyethylene film in a bar coating method using a doctor blade. A low-temperature air flow was applied to the film coated with the coating slurry, and the process of drying to remove the dispersion medium was repeated five times while controlling the surface temperature of the coating layer so as not to exceed 50° C. to form a coating layer with a thickness of 2 μm.

### Example 2

A separator was manufactured in the same manner as in Example 1, except that both sides of the polyethylene film were each coated to have a coating thickness of 1 μm.

### Example 3

A separator was manufactured in the same manner as in Example 1, except that both sides of the polyethylene film were each coated to have a coating thickness of 0.5 μm.

### Example 4

A separator was manufactured in the same manner as in Example 1, except that the inorganic particles, polymer binder, and Li-CNF-APTES were added at a weight ratio of 88:2:10 during the preparation of the coating slurry.

### Example 5

A separator was manufactured in the same manner as in Example 1, except that lithium hydroxide and APTES were added at a molar ratio of 10:1 in the preparation of cellulose nanofibers (CNFs).

### Example 6

A separator was manufactured in the same manner as in Example 1, except that tetraethoxysilane (TEOS) (Sigma Aldrich) was used as the silane material.

### Example 7

A separator was manufactured in the same manner as in Example 1, except that lithium hydroxide and APTES were added at a molar ratio of 4:1 during the preparation of cellulose nanofibers (CNFs).

### Comparative Example 1

A separator was manufactured in the same manner as in Example 1, except that a coating slurry prepared by adding inorganic particles and a polymer binder at a weight ratio of 95:5 without using cellulose nanofibers (CNFs) was used.

### Comparative Example 2

A separator was manufactured in the same manner as in Example 2, except that a coating slurry prepared by adding inorganic particles and a polymer binder at a weight ratio of 95:5 without using cellulose nanofibers (CNFs) was used.

### Comparative Example 3

A separator was manufactured in the same manner as in Example 3, except that a coating slurry prepared by adding inorganic particles and a polymer binder at a weight ratio of 95:5 without using cellulose nanofibers (CNFs) was used.

### Comparative Example 4

A separator was manufactured in the same manner as in Example 1, except that cellulose nanofibers (CNFs) into which lithium ions and silane were not introduced were used.

### Comparative Example 5

A separator was manufactured in the same manner as in Example 2, except that cellulose nanofibers (CNFs) into which lithium ions and silane were not introduced were used.

### Comparative Example 6

A separator was manufactured in the same manner as in Example 1, except that Li-CNF prepared without adding APTES to the cellulose nanofiber dispersion was used.

### Comparative Example 7

A separator was manufactured in the same manner as in Example 2, except that Li-CNF prepared without adding APTES to the cellulose nanofiber dispersion was used.

### Experimental Example: Evaluation of Separator Physical Property

### Measurement of Air Permeability

The time required for 100 cc of air to pass through a separator with a diameter of 28.6 mm and an area of 645 mm² was measured using a Gurley densometer (Model 4110N, Gurley).

### Measurement of Water Contact Angle

After dropping 1 μl of water onto the surface of each of the separators of the examples and comparative examples, the water contact angle at room temperature was measured using a contact angle measuring device (Attension Theta Flex, Biolin Scientific).

### Measurement of Moisture Content

After sampling each of the separators of the examples and comparative examples to a weight of 0.07 g, the moisture content was measured under conditions of 120° C. and an N₂ flow rate of 60 ml/min using a moisture measuring device (831 Coulometer, Metrohm).

### Measurement of Electrical Resistance

Individual coin cells were fabricated by sandwiching the separators of the examples and comparative examples, respectively, between SUS sheets. An electrolyte containing 1M LiPF₆ and a mixture of ethylene carbonate and ethyl methyl carbonate at a volume ratio of 1:2 was injected into the coin cells. To measure the resistance of the coin cells, electrochemical impedance spectroscopy was performed using a VMP3 (BioLogic Science Instrument) at 25° C. under conditions of an amplitude of 10 mV and a scan range of 0.1 Hz to 1 MHz, and the resistance was determined based on the analysis results.

### Evaluation of Electrochemical Device Lifetime Characteristics

After weighing lithium-manganese composite oxide (LiMnO₂), conductive material (Denka black), and binder (PVdF) in a weight ratio of 95:2.5:2.5, a positive electrode active material slurry was prepared by mixing them in N-methylpyrrolidone (NMP). The positive electrode active material slurry was coated to a thickness of 100 μm onto a 20 μm thick aluminum foil, and then rolled and dried to fabricate a positive electrode.

A 100 μm thick Li metal plate was used as a negative electrode. The positive electrode and the negative electrode were stacked with a separator of an example or comparative example interposed therebetween, and then inserted into an aluminum pouch.

An electrolyte, containing 1 mol of lithium salt LiPF₆ in a solvent prepared by mixing ethylene carbonate (EC) and diethyl carbonate (DEC) at a volume ratio of 1:1, was injected into the aluminum pouch to fabricate coin cells.

The coin cells were subjected to charge/discharge once at 1.0 C in a voltage range of 3.0 V to 4.2 V in a 60° C. chamber. Subsequently, three repeated charge/discharge cycles (1.0 C charge and 1.0 C discharge) were performed, and the capacity retention was evaluated and presented in Table 1. The capacity retention in Table 1 was calculated as the ratio of the discharge capacity after three repeated cycles to the initial discharge capacity.

### Measurement of Puncture Strength

The maximum load value was measured according to ASTM D5748-95 and ASTM D4649 when the individual separators of the examples and comparative examples were pierced with a needle with a diameter of 1 mm (0.5 mmR) at a speed of 120 mm/min. The measurement was performed five times for each separator, and the average value was calculated using an Instron testing machine.

TABLE 1

| | Example | Example | Example | Example | Example | Example | Example |
|---|---|---|---|---|---|---|---|
| | 1 | 2 | 3 | 4 | 5 | 6 | 7 |
| Used cellulose | Li-CNF- | Li-CNF- | Li-CNF- | Li-CNF- | Li-CNF- | Li-CNF- | Li-CNF- |
| nanofibers | APTES | APTES | APTES | APTES | APTES | TEOS | APTES |
| Introduced lithium | 20:1 | 20:1 | 20:1 | 20:1 | 10:1 | 10:1 | 4:1 |
| ion:silane molar | | | | | | | |
| ratio | | | | | | | |
| Coating layer weight | 94:3:3 | 94:3:3 | 94:3:3 | 88:2:10 | 94:3:3 | 94:3:3 | 94:3:3 |
| ratio (inorganic | | | | | | | |
| particles:polymer | | | | | | | |
| binder:cellulose | | | | | | | |
| nanofibers) | | | | | | | |
| One side/both sides | one side | Both | Both | One side | One side | One side | One side |
| | | sides | sides | | | | |
| Coating layer | 2 | 1/1 | 0.5/0.5 | 2 | 2 | 2 | 2 |
| thickness (μm) | | | | | | | |
| Total separator | 12.2 | 12.3 | 11.2 | 12.0 | 12.1 | 12.3 | 12.2 |
| thickness (μm) | | | | | | | |
| Air permeability | 94 | 88 | 85 | 101 | 97 | 98 | 121 |
| (s/100 cc) | | | | | | | |
| Water contact angle | 130 | 125 | 126 | 115 | 117 | 112 | 134 |
| (°) | | | | | | | |
| Moisture content | 1023 | 830 | 788 | 815 | 987 | 990 | 925 |
| (ppm) | | | | | | | |
| Electrical resistance | 0.51 | 0.49 | 0.57 | 0.58 | 0.45 | 0.51 | 0.58 |
| (Ω) | | | | | | | |
| Capacity retention | 94.5 | 94.8 | 95.6 | 95.4 | 93.8 | 94.2 | 93.8 |
| (%) | | | | | | | |
| Puncture strength (gf) | 667 | 479 | 521 | 460 | 421 | 453 | 398 |

TABLE 2

| | Comp. | Comp. | Comp. | Comp. | Comp. | Comp. | Comp. |
|---|---|---|---|---|---|---|---|
| | Exam. 1 | Exam. 2 | Exam. 3 | Exam. 4 | Exam. 5 | Exam. 6 | Exam. 7 |
| Used cellulose | — | — | — | CNF | CNF | Li-CNF | Li-CNF |
| nanofibers | | | | | | | |
| Introduced lithium | — | — | — | — | — | — | — |
| ion:silane molar | | | | | | | |
| ratio | | | | | | | |
| Coating layer weight | 95:5:0 | 95:5:0 | 95:5:0 | 94:3:3 | 94:3:3 | 94:3:3 | 94:3:3 |
| ratio (inorganic | | | | | | | |
| particles:polymer | | | | | | | |
| binder:cellulose | | | | | | | |
| nanofibers) | | | | | | | |
| One side/both sides | One side | Both | Both | One side | Both | One side | Both |
| | | sides | sides | | sides | | sides |
| Coating layer | 2 | 1/1 | 0.5/0.5 | 2 | 1/1 | 2 | 1/1 |
| thickness (μm) | | | | | | | |
| Total separator | 12.3 | 12.5 | 11.5 | 12.1 | 11.9 | 12.4 | 12.0 |
| thickness (μm) | | | | | | | |
| Air permeability | 83 | 78 | 80 | 143 | 100 | 138 | 100 |
| (s/100 cc) | | | | | | | |
| Water contact angle | 82 | 78 | 81 | 64 | 67 | 75 | 70 |
| (°) | | | | | | | |
| Moisture content | 1670 | 1413 | 1321 | 2750 | 2880 | 1738 | 1863 |
| (ppm) | | | | | | | |
| Electrical resistance | 0.66 | 0.64 | 0.65 | 0.65 | 0.60 | 0.58 | 0.57 |
| (Ω) | | | | | | | |
| Capacity retention | 93.2 | 93.7 | 93.8 | 93.9 | 94.0 | 94.3 | 94.1 |
| (%) | | | | | | | |
| Puncture strength (gf) | 443 | 475 | 468 | 470 | 513 | 491 | 521 |

Referring to Tables 1 and 2, it can be seen that, for Examples 1 to 7, in which lithium and silane components were introduced into cellulose nanofibers (CNFs), the separators exhibit relatively lower moisture content and reduced resistance compared to Comparative Examples 1 to 7 in which lithium and silane components were not introduced. For example, the moisture content of the separators in Examples 1 to 7 ranged from about 788 ppm to 1023 ppm, whereas the moisture content of the separators in Comparative Examples 1 to 7 ranged from about 1321 ppm to 2880 ppm. The water contact angle in Examples 1 to 7 ranged from 1120 to 134°, whereas Comparative Examples 1 to 7 exhibited much smaller values, ranging from 64° to 82°. In addition, for electrical resistance, some of the examples exhibited values of about 0.5Ω or less, whereas the electrical resistance in most of the comparative Examples exceeded 0.5Ω.

Although the present disclosure has been described with reference to exemplary drawings as illustrated above, it is apparent that the present disclosure is not limited to the embodiments and drawings disclosed herein, and that various modifications may be made by those ordinarily skilled in the art within the spirit and scope of the present disclosure. Furthermore, even if operational effects according to the configuration of the present disclosure have not been explicitly described above in the course of describing the embodiments of the present disclosure, it is natural that predictable effects according to the configuration should also be considered to fall within the scope of the present disclosure.

What is claimed is:

1. A separator for an electrochemical device, the separator comprising:
a porous substrate; and
a coating layer formed on at least one surface of the porous substrate,
wherein the coating layer includes inorganic particles, a polymer binder, and cellulose nanofibers, and
wherein lithium ions and silane are introduced into the cellulose nanofibers.

2. The separator according to claim 1, wherein the lithium ions and the silane are introduced into the cellulose nanofibers at a molar ratio from 5:1 to 25:1.

3. The separator according to claim 1, wherein the coating layer includes the cellulose nanofibers in an amount from 1 wt % to 15 wt %.

4. The separator according to claim 1, wherein an average diameter of the cellulose nanofibers ranges from 5 nm to 50 nm.

5. The separator according to claim 1, wherein an aspect ratio of the cellulose nanofibers ranges from 50 to 200.

6. The separator according to claim 1, wherein the silane is one or more selected from N-2-(aminoethyl)-3-aminopropylmethyldimethoxysilane, N-2-(aminoethyl)-3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, vinyltrimethoxysilane, vinyltriethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, tris-(trimethoxysilylpropyl)isocyanurate, 3-mercaptopropylmethyldimethoxysilane, 3-mercaptopropyltrimethoxysilane, and 3-isocyanatopropyltriethoxysilane.

7. The separator according to claim 1, wherein a thickness of the coating layer ranges from 0.5 μm to 2 μm.

8. The separator according to claim 1, wherein a content of the inorganic particles with respect to a total weight of the coating layer ranges from 80 wt % to 95 wt %.

9. The separator according to claim 1, further comprising:
an adhesive layer formed on a surface of the coating layer.

10. An electrochemical device comprising:
a positive electrode;
a negative electrode; and
a separator interposed between the positive electrode and the negative electrode,
wherein the separator is the separator for an electrochemical device according to claim 1.
